(19) United States
(12) Patent Application Publication
(10) Pub. No.: US 2024/0103280 A1
(43) Pub. Date: Mar. 28, 2024

(54) Display with Lens Integrated Into Cover Layer

(71) Applicant: Apple Inc., Cupertino, CA (US)

(72) Inventors: Barbara J. Kruse, San Francisco, CA (US); Vikrant Bhakta, Santa Clara, CA (US); John Raff, Menlo Park, CA (US); Cameron A. Harder, San Francisco, CA (US); Nawaf Al-Baghly, San Jose, CA (US)

(21) Appl. No.: 18/467,459

(22) Filed: Sep. 14, 2023

Related U.S. Application Data
(60) Provisional application No. 63/409,093, filed on Sep. 22, 2022.

(51) Int. Cl. G02B 27/01

(52) U.S. Cl. CPC G02B 27/0172; G02B 2027/0178

(57) ABSTRACT

A display may include a waveguide having an output coupler that couples image light out of the waveguide and towards a lens, which imparts a first power to the image light. A cover layer may have an outer surface with a three-dimensional curvature and an inner surface. A portion of the inner surface overlapping the output coupler may have a different three-dimensional curvature that forms an additional lens in the cover layer that transmits world light to the output coupler. The output coupler may transmit the world light to the lens, which transmits the world and image light to the eye box. The curvature of the portion of the inner surface may impart power to the world light that reverses the first power and/or a power imparted to the world light by the outer surface of the cover layer.

This application claims the benefit of U.S. Provisional Patent Application No. 63/409,093, filed Sep. 22, 2022, which is hereby incorporated by reference herein in its entirety.

### BACKGROUND

This disclosure relates to optical systems such as optical systems in electronic devices having displays.

Electronic devices can include displays that provide images near the eyes of a user. Such electronic devices often include virtual or augmented reality headsets with displays having optical elements that allow users to view the displays. If care is not taken, components used to display images can be bulky and might not exhibit desired levels of optical performance.

### SUMMARY

An electronic device may have a display system for providing image light to an eye box. The display system may include a waveguide. The waveguide may propagate image light coupled into the waveguide from a projector. An output coupler on the waveguide may couple the image light out of the waveguide and towards a lens. The lens may impart a first power to the image light to provide virtual objects in the image light to the eye box at a desired virtual image distance and/or to implement a user's corrective prescription.

A cover layer may overlap the output coupler and the lens. The cover layer may have an outer surface and an inner surface. The outer surface may have a three-dimensional curvature. The inner surface may have a portion overlapping the output coupler with a different three-dimensional curvature. The portion of the inner surface may form an additional lens that is integrated into the cover layer and that transmits world light to the output coupler. The output coupler may transmit the world light to the lens. The lens may transmit the world light and the image light to the eye box. The three-dimensional curvature of the portion of the inner surface of the cover layer (the lens integrated into the cover layer) may be selected to impart an optical power to the world light that reverses the first optical power and/or an optical power imparted to the world light by transmission through the outer surface of the cover layer. The cover layer may overlap a single display or two displays (e.g., left and right displays) of the device.

### BRIEF DESCRIPTION OF THE DRAWINGS

FIG. 1 is a diagram of an illustrative system having a display in accordance with some embodiments.

FIG. 2 is a top view of an illustrative optical system for a display having a cover layer and a waveguide with optical couplers in accordance with some embodiments.

FIG. 3 is a top view showing how an illustrative cover layer for a display may have an integrated lens in accordance with some embodiments.

FIG. 4 is a top view showing how different waveguides may be provided with different illustrative cover layers having respective integrated lenses in accordance with some embodiments.

FIG. 5 is a top view showing how different waveguides may share an illustrative cover layer having multiple integrated lenses in accordance with some embodiments.

### DETAILED DESCRIPTION

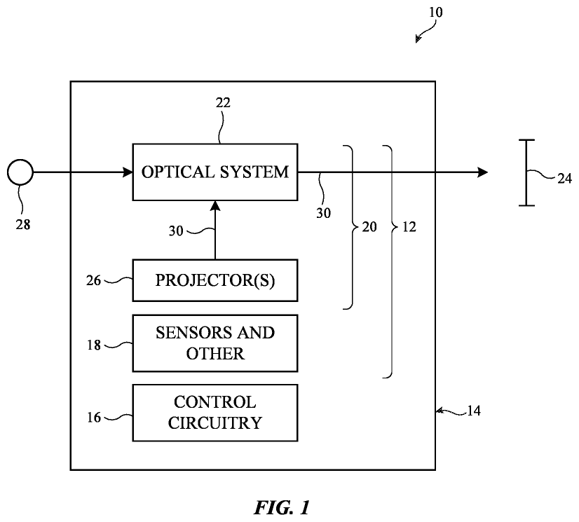

System 10 of FIG. 1 may be a head-mounted device having one or more displays. The displays in system 10 may include near-eye displays 20 mounted within support structure (housing) 14. Support structure 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as support structure 14. Each projector 26 may emit image light 30 that is redirected towards a user's eyes at eye box 24 using an associated one of optical systems 22. Image light 30 may be, for example, light that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner, etc.) to allow real-world image light from real-world images or objects (e.g., real-world objects 28) to be combined optically with virtual (computer-generated) images such as virtual images in image light 30. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of external objects and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

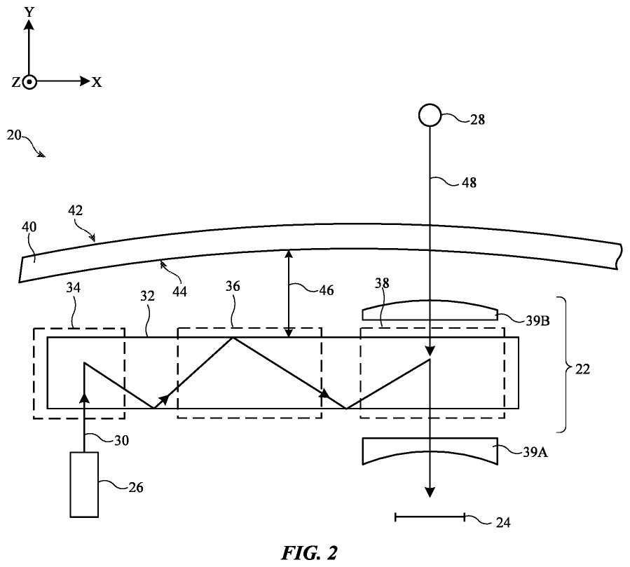

FIG. 2 is a top view of an illustrative display 20 that may be used in system 10 of FIG. 1. As shown in FIG. 2, display 20 may include a projector such as projector 26 and an optical system such as optical system 22. Optical system 22 may include optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer), gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 whereas optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection. Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), or any other desired input coupling elements.

As an example, projector 26 may emit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is merely illustrative. Optical system 22 may include multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 may include a single optical coupler that performs the operations of both cross-coupler 36 and output coupler 38 (sometimes referred to herein as an interleaved coupler, a diamond coupler, or a diamond expander) or cross-coupler 36 may be separate from output coupler 38.

Image light 30 may include images of virtual objects, sometimes referred to herein as virtual object images or simply as virtual objects. Projector 26 may receive image data that includes the virtual object images (e.g., pixels of image data at different pixel locations that form the virtual object images). Output coupler 38 may serve to overlay the virtual object images with world light 48 from real-world object 28 within the field of view (FOV) of eye box 24. The control circuitry for system 10 may provide image data to projector 26 that places the virtual object images at desired locations within the FOV at eye box 24 (e.g., such that the virtual object images are overlaid with desired real-world objects in the scene/environment in front of system 10.)

If desired, optical system 22 may include one or more lenses 39 that overlap output coupler 38 (e.g., an optical combiner on waveguide 32). For example, optical system 22 may include at least a first lens 39A and a second lens 39B. Lens 39B may be interposed between waveguide 32 and real-world object 28 (sometimes referred to herein as external object 28). Lens 39A may be interposed between waveguide 32 and eye box 24. Lenses 39 are transparent and allow world light 48 from real-world object 28 to pass to eye box 24 for viewing by the user. At the same time, the user can view virtual object images (in image light 30) directed out of waveguide 32 and through lens 39A to eye box 24.

The strength (sometimes referred to as the optical power, power, or diopter) of lens 39A can be selected to place virtual object images in image light 30 at a desired image distance (depth) from eye box 24 (sometimes referred to herein as a virtual object distance, virtual object image distance, virtual image distance (VID), virtual object depth, virtual image depth, or image depth). For example, it may be desirable to place virtual objects (virtual object images) such as text, icons, moving images, characters, effects, or other content or features at a certain virtual image distance (e.g., to integrate the virtual object image within, onto, into, or around the real-world objects in front of system 10). The placement of the virtual object at that distance can be accomplished by appropriate selection of the strength of lens 39A. Lens 39A may be a negative lens for users whose eyes do not have refraction errors. The strength (larger net negative power) of lens 39A can therefore be selected to adjust the distance (depth) of the virtual object. Lens 39A may therefore sometimes be referred to herein as bias lens 39A or bias− (B−) lens 39A.

If desired, lens 39B may have a complementary power value (e.g., a positive power with a magnitude that matches the magnitude of the negative power of lens 39A). Lens 39B may therefore sometimes be referred to herein as bias+(B+) lens 39B, complementary lens 39B, or compensation lens 39B. For example, if lens 39A has a power of −2.0 diopter, lens 39B may have an equal and opposite power of +2.0 diopter (as an example). In this type of arrangement, the positive power of lens 39B cancels the negative power of lens 39A. As a result, the overall power of lenses 39A and 39B taken together will be 0 diopter. For example, a real-world object 28 located far away from system 10 (effectively at infinity), may be viewed as if lenses 39A and 39B were not present. This allows a viewer to view real-world objects such as real-world object 28 without optical influence from lenses 39A and 39B, while concurrently placing virtual objects at a desired VID.

For a user with satisfactory uncorrected vision, this type of complementary lens arrangement therefore allows virtual objects to be placed in close proximity to the user (e.g., at a virtual image distance of 0.5-5 m, at least 0.1 m, at least 1 m, at least 2 m, less than 20 m, less than 10 m, less than 5 m, or other suitable near-to-midrange distance from device 10 while simultaneously allowing the user to view real world objects without modification by the optical components of the optical system). For example, a real-world object located at a distance of 2 m from eye box 24 (e.g., a real-world object being labeled by a virtual text label at a virtual image distance of 2 m) will optically appear to be located 2 m from eye box 24. This is merely illustrative and, if desired, lenses 39A and 39B need not be complementary lenses (e.g., lenses 39A and 39B may have any desired optical powers).

In addition, some users may require vision correction. Vision correction may be provided using tunable lenses, fixed (e.g., removable) lenses (sometimes referred to as supplemental lenses, vision correction lenses, removable lenses, or clip-on lenses), and/or by adjusting the optical power of lens 39A and/or lens 39B to implement the desired vision correction. In general, the vision correction imparted to the lens(es) may include corrections for ammetropia (eyes with refractive errors) such as lenses to correct for nearsightedness (myopia), corrections for farsightedness (hyperopia), corrections for astigmatism, corrections for skewed vision, corrections to help accommodate age-related reductions in the range of accommodation exhibited by the eyes (sometimes referred to as presbyopia), and/or other vision disorders.

Lenses 39A and 39B may be provided with any desired optical powers and any desired shapes (e.g., may be plano-convex lenses, plano-concave lenses, plano-freeform lenses, freeform-convex lenses, freeform-concave lenses, convex-concave lenses, etc.).

Implementations in which the optical power(s) of lenses 39A and/or 39B are fixed (e.g., upon manufacture) are described herein as an example. If desired, one or both of lenses 39A and/or 39B may be electrically adjustable to impart different optical powers or power profiles over time (e.g., lenses 39A and/or 39B may be adjustable/tunable liquid crystal lenses). If desired, lens 39A may have different regions with different powers or focal lengths to provide virtual object images at different VIDs within different regions of eye box 24. Lens 39B may have different regions with powers or focal lengths that reverse the powers or focal lengths of lens 39A.

If desired, display 20 may be provided with a cover layer such as cover layer 40. Cover layer 40 may overlap optical system 22 on the world-facing side of system 10 (e.g., cover layer 40 may be interposed between waveguide 32 and real-world object 28). Cover layer 40 may have a first (outer or exterior) surface 42 facing real-world object 28 and an opposing second (inner or interior) surface 44 facing waveguide 32. Surface 44 may be separated from waveguide 32 by distance (gap) 46. Lens 39B may be disposed between waveguide 32 and cover layer 40 within distance 46.

Cover layer 40 may be a transparent member that passes world light 48 to output coupler 38. Cover layer 40 may be formed from dielectric material such as plastic. Cover layer 40 may, if desired, form part of or may be integral to the housing for system 10. Cover layer 40 may be fixed in place on display 20 or may be removable if desired. Cover layer 40 may contribute to the aesthetic/cosmetic appearance of system 10 while also serving to protect waveguide 32 from contaminants or damage during operation.

As shown in FIG. 2, world light 48 may be transmitted through cover layer 40 to lens 39B, which transmits world light 48 to output coupler 38, which transmits world light 48 to lens 39A, with transmits world light 48 to eye box 24 (e.g., overlaid with virtual objects in image light 30). Surface 42 of cover layer 40 may have a non-zero curvature that is selected to optimize the cosmetic/aesthetic appearance and/or tactile experience for system 10. The curvature of surface 42 may be a two-dimensional curvature (e.g., about a single axis) or a three-dimensional curvature (e.g., about two or more non-parallel axes). The curvature of surface 42 may, for example, be a freeform or anamorphic curvature.

Surface 44 of cover layer 40 may also have a non-zero curvature. The curvature of surface 44 may be a two-dimensional curvature (e.g., about a single axis) or a three-dimensional curvature (e.g., about two or more non-parallel axes). The curvature of surface 44 may, for example, be a freeform curvature or an anamorphic curvature. The curvature of surface 44 may be selected so that some or all of surface 44 extends parallel to overlapping portion(s) of surface 42, to minimize the thickness of cover layer 40 and thus the weight and volume of cover layer 40, to minimize or maximize distance 46, to ensure that cover layer 40 exhibits a desired amount of mechanical integrity, and/or to compensate for the refractive effects (e.g., power) of surface 42 on world light 48.

For example, the curvature of surface 42 imparts optical power to transmitted light. As such, upon transmission through surface 42 of cover layer 40, the curvature of surface 42 can impart non-zero optical power to world light 48 (e.g., different non-zero optical powers at different points on the surface based on the curvature of the surface). If desired, the curvature of surface 44 may be selected to exhibit opposite power(s) (e.g., different non-zero optical powers at different points on the surface based on the curvature of the surface) such that, upon transmission through surface 44, the curvature of surface 44 reverses any power imparted to world light 48 by transmission through surface 42. Additionally or alternatively, lens 39B may have a lens profile (curvature(s) in one or more lens surfaces) that is selected such that, upon transmission through lens 39B, lens 39B reverses any power imparted to world light 48 by transmission through surface 42 and/or surface 44 (e.g., in addition to pre-reversing the effects of lens 39A on world light 48).

Space is at a premium in displays such as display 20. Using lens 39B to operate on world light 48 can consume an excessive amount of space within device 10 (e.g., at least distance 46) and can unnecessarily increase the complexity and cost of device 10. In addition, lens 39B can be subject to damage or misalignment during the operating life of system 10. To mitigate these issues, surface 44 of cover layer 40 may be curved to perform the refractive operations of lens 39B on world light 48 (e.g., to impart the same power(s) as lens 39B to world light 48), thereby allowing lens 39B to be omitted from system 10. This may serve to minimize distance 46 and thus the volume of display 20, to decrease the complexity and cost of system 10, and/or to enhance the mechanical robustness of system 10 over its operating life.

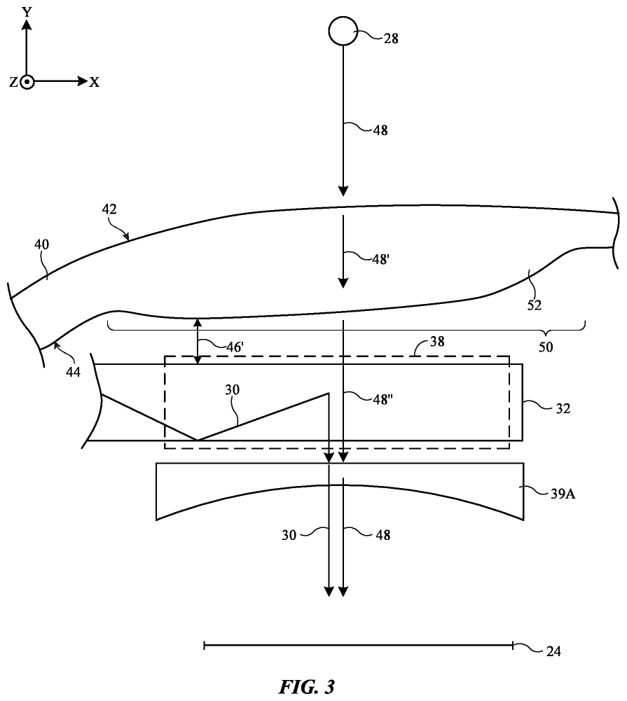

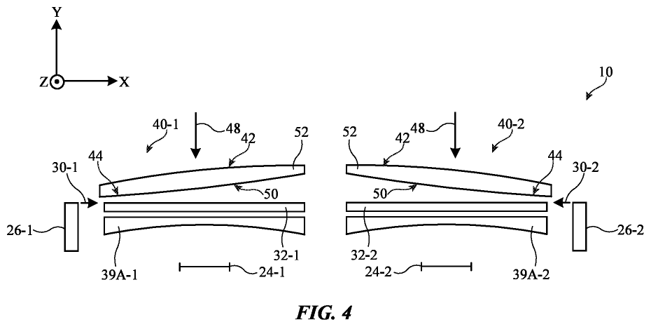

FIG. 3 is a top view showing how cover layer 40 may be curved to perform the refractive operations of lens 39B on world light 48. As shown in FIG. 4, a portion (region or area) 50 of surface 44 of cover layer 40 may overlap output coupler 38 and eye box 24. If desired, the curvature of portion 50 may differ from the curvature(s) of the remainder of surface 44 outside of portion 50. The curvature of portion 50 of surface 44 may be a freeform curvature, anamorphic curvature, or other curvature selected to integrate the optical (refractive) effects (e.g., power or focal length) of lens 39B (FIG. 2) into cover layer 40 itself (e.g., cover layer 40 may form lens 39B of FIG. 2). This may, for example, configure cover layer 40 to form a lens 52 (e.g., a thicker or protruding curved portion of the cover layer) overlapping output coupler 38.

The curvature of portion 50 of surface 44 of cover layer 40 (e.g., the curvature of lens 52 in cover layer 40) may, for example, be selected to both perform the operation of lens 39B and to reverse the optical effects of surface 42 on world light 48. In other words, the curvature of portion 50 of surface 44 may, for example, include a first curvature selected to reverse the optical effects of surface 42 on world light 48 superimposed with (onto) a second curvature selected to perform the optical effects of lens 39B of FIG. 2 (e.g., to reverse the power imparted onto world light 48 by lens 39A, which places virtual objects in image light 30 at desired image distance(s) from the eye box).

For example, as shown in FIG. 3, world light 48 from external object 28 (e.g., emitted or reflected by external object 28) may be incident upon cover layer 40 of display 20. World light 48 may be transmitted through surface 42 of cover layer 40. The curvature (e.g., three-dimensional freeform curvature) of surface 42 (e.g., as selected to optimize the aesthetic and tactile experience of system 10) may operate on (e.g., refract) the transmitted world light 48 (e.g., by imparting power(s) corresponding to the curvature), thereby producing world light 48′ within cover layer 40.

World light 48′ may pass through cover layer 40 and may be transmitted through portion 50 of surface 44 of cover layer 40. The curvature (e.g., three-dimensional freeform or anamorphic curvature) of portion 50 of surface 44 (e.g., lens 52) may reverse the optical effects (refraction) produced on the world light by transmission through surface 42. The curvature of portion 50 of surface 44 (lens 52) may concurrently perform the optical effects of lens 39B of FIG. 2. In other words, the curvature of portion 50 of surface 44 (lens 52) may also reverse the subsequent optical effects (refraction) that will be produced on the world light by transmission through lens 39A (e.g., to reverse the effects of lens 39A on the world light as needed to place virtual object(s) in image light 30 at desired VIDs from eye box 24 and/or to incorporate a user's vision correction prescription). As such, portion 50 of surface 44 of cover layer 40 (e.g., lens 52) may impart optical power(s) to world light 48′ that reverse (compensate for) both the optical power(s) produced by surface 42 and the optical power(s) produced by lens 39A to produce (transmit) world light 48″ towards waveguide 32.

Output coupler 38 may receive and transmit world light 48″ (e.g., without diffracting the world light). Output coupler 38 may transmit world light 48″ out of waveguide 32 and towards lens 39A while concurrently coupling (e.g., diffracting) image light 30 out of waveguide 32 and towards lens 39A. Lens 39A may transmit image light 30 while imparting its corresponding optical power(s) to image light 30, thereby placing virtual objects at desired VID(s) from eye box 24 and/or applying a user's vision correction prescription to the light. Lens 39A may also concurrently transmit world light 48″ while imparting its corresponding optical power(s) to image light 48. Since the world light has already been pre-compensated for the optical power(s) of lens 39A by lens 52 in cover layer 50, the optical power(s) of lens 39A may reverse the optical power(s) imparted to the world light by lens 52 in cover layer 50, thereby recovering the original world light 48 received at cover layer 40, which is then transmitted to eye box 24.

In this way, lens 52 in cover layer 40 (e.g., the curvature of portion 50 of surface 44) may effectively mitigate the optical effects on world light 48 produced by both the curvature of surface 42 of cover layer 40 and lens 39A, thereby allowing undistorted world light to be received at the eye box. By forming lens 52 within cover layer 40 itself, lens 39B of FIG. 2 may be omitted, thereby reducing the distance between cover layer 40 and waveguide 32 to reduced distance 46′ (e.g., helping to make system 10 as compact and robust as possible).

If desired, system 10 may include different respective cover layers 40 for each of the displays 20 in system 10 (e.g., left and right displays 20). FIG. 4 is a top view showing one example of how system 10 may include different respective cover layers 40 for each of the displays 20 in system 10.

As shown in FIG. 4, system 10 may include a first projector 26-1 that provides first image light 30-1 to a first waveguide 32-1 that directs first image light 30-1 to a first eye box 24-1 (e.g., a left eye box) through a first lens 39A-1 (e.g., for a first or left display 20 in system 10). System 10 may also include a second projector 26-2 that provides first image light 30-2 to a second waveguide 32-2 that directs second image light 30-2 to a second eye box 24-2 (e.g., a right eye box) through a second lens 39A-2 (e.g., for a second or right display 20 in system 10).

System 10 may include a first cover layer 40-1 that covers (overlaps) waveguide 32-1, lens 39A-1, and eye box 24-1 (e.g., the first display). First cover layer 40-1 may include a lens 52 formed from the curvature of portion 50 of the surface 44 of first cover layer 40-1 (e.g., where portion 50 overlaps eye box 24-1). Lens 52 may reverse the optical effects of the surface 42 of first cover layer 40-1 and may reverse the subsequent optical effects of lens 39A-1 on the world light 48 transmitted to eye box 24-1 through first cover layer 40-1.

As shown in FIG. 4, system 10 may also include a second cover layer 40-2 that covers (overlaps) waveguide 32-2, lens 39A-2, and eye box 24-2 (e.g., the second display). Second cover layer 40-2 may be separate (e.g., may be formed from a separate piece of transparent material) from first cover layer 40-1. Second cover layer 40-2 may include a lens 52 formed from the curvature of portion 50 of the surface 44 of second cover layer 40-2 (e.g., where portion 50 overlaps eye box 24-2). Lens 52 may reverse the optical effects of the surface 42 of second cover layer 40-2 and may reverse the subsequent optical effects of lens 39A-2 on the world light 48 transmitted to eye box 24-2 through second cover layer 40-2.

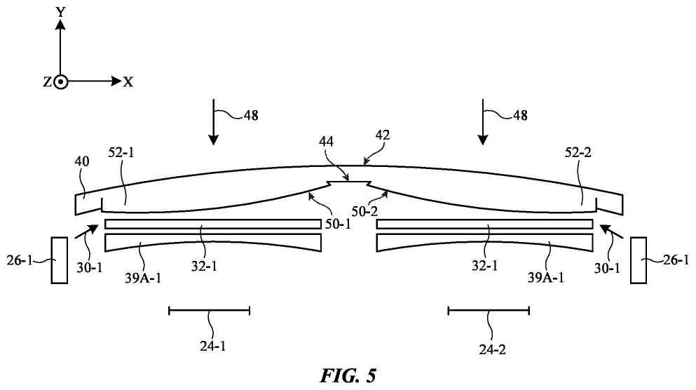

The example of FIG. 4 is merely illustrative. In other implementations, a single cover layer 40 may cover both the left and right displays for system 10. FIG. 5 is a top view showing one example of how a single cover layer 40 may cover both the left and right displays for system 10.

As shown in FIG. 5, system 10 may include a single (shared or common) cover layer 40 that covers (overlaps) both waveguides 32-1 and 32-2, both lenses 39A-1 and 39A-2, and both eye boxes 24-1 and 24-2. Cover layer 40 may include a first lens 52-1 formed from the curvature of a first portion 50-1 of the surface 44 of cover layer 40 (e.g., where lens 52-1 and portion 50-1 overlap waveguide 32-1, lens 39A-1, and eye box 24-1). Lens 52-1 may reverse the optical effects of the surface 42 of cover layer 40 and may reverse the subsequent optical effects of lens 39A-1 on the world light 48 transmitted to eye box 24-1 through cover layer 40.

Cover layer 40 may also include a second lens 52-2 formed from the curvature of a second portion 50-2 of the surface 44 of cover layer 40 (e.g., where lens 52-2 and portion 50-2 overlap waveguide 32-2, lens 39A-2, and eye box 24-2). Lens 52-2 may reverse the optical effects of the surface 42 of cover layer 40 and may reverse the subsequent optical effects of lens 39A-2 on the world light 48 transmitted to eye box 24-2 through cover layer 40.

By integrating lenses into cover layer 40, the volume, weight, thickness, cost, part count, and manufacturing complexity of system 10 may be minimized without sacrificing optical performance. Removing lens 39B (FIG. 2) also serves to minimize the number of reflective surfaces in the optical path (e.g., surfaces that may reflect at least some of world light 48 and/or image light 30), thereby helping to minimize ghost artifacts at the eye boxes.

The foregoing is merely illustrative and various modifications can be made to the described embodiments. The foregoing embodiments may be implemented individually or in any combination.

What is claimed is:

1. An electronic device comprising:
a waveguide configured to propagate first light;
a cover layer overlapping the waveguide;
an output coupler on the waveguide;
a first lens integrated into the cover layer and overlapping the output coupler, the first lens being configured to transmit second light from an external object towards the output coupler; and
a second lens, wherein the output coupler is configured to couple the first light out of the waveguide and towards the second lens and is configured to transmit the second light towards the second lens.

2. The electronic device of claim 1, wherein the cover layer has a first surface facing the waveguide and a second surface opposite the first surface, the second surface being curved.

3. The electronic device of claim 2, wherein the second surface has a three-dimensional curvature.

4. The electronic device of claim 3, wherein three-dimensional curvature imparts a first power to the second light and the lens is configured to reverse the first power imparted to the second light by the three-dimensional curvature.

5. The electronic device of claim 4, wherein the second lens is configured to impart a second power to the second light and the lens is further configured to reverse the second power imparted to the second light by the second lens.

6. The electronic device of claim 3, wherein the first surface is curved.

7. The electronic device of claim 6, wherein the lens comprises a portion of the first surface that overlaps the output coupler and that has an additional three-dimensional curvature.

8. The electronic device of claim 7, wherein the additional three-dimensional curvature of the portion of the first surface is different from a curvature of the first surface outside of the portion.

9. The electronic device of claim 7, wherein the additional three-dimensional curvature comprises a freeform curvature.

10. The electronic device of claim 7, wherein the additional three-dimensional curvature comprises an anamorphic curvature.

11. The electronic device of claim 1, wherein the second lens is configured to impart a power to the second light and the lens is configured to reverse the power imparted to the second light by the second lens.

12. The electronic device of claim 1, further comprising:
an additional waveguide configured to propagate third light;
an additional cover layer separate from the cover layer and overlapping the additional waveguide;
an additional output coupler on the waveguide;
a third lens integrated into the additional cover layer and overlapping the additional output coupler, the third lens being configured to transmit the second light from the external object towards the additional output coupler; and
a fourth lens, wherein the additional output coupler is configured to couple the third light out of the additional waveguide and towards the fourth lens and is configured to transmit the second light towards the fourth lens.

13. The electronic device of claim 12, wherein the first lens is configured to pre-compensate the second light for a first power imparted to the second light by the second lens and the third lens is configured to pre-compensate the second light for a second power imparted to the second light by the fourth lens.

14. An electronic device comprising:
a lens;
a waveguide configured to propagate first light;
an optical coupler on the waveguide and configured to couple the first light out of the waveguide and towards the lens; and
a cover layer having a first surface facing away from the waveguide and having a second surface opposite the first surface, wherein
the first surface has a first curvature,
a portion of the second surface overlapping the output coupler has a second curvature,
the second surface has, outside of the portion, a third curvature that is different from the second curvature,
the cover layer is configured to transmit second light towards the waveguide through the portion of the second surface,
the output coupler is configured to transmit the second light towards the lens, and
the lens is configured to transmit the first light and the second light.

15. The electronic device of claim 14, wherein the first curvature is a first three-dimensional curvature and the second curvature is a second three-dimensional curvature that is different from the first three-dimensional curvature.

16. The electronic device of claim 15, wherein the second three-dimensional curvature comprises a freeform curvature.

17. The electronic device of claim 14, wherein the second light is received at the first surface of the cover layer, the first surface of the cover layer imparts a first power to the second light, the lens is configured to impart a second power to the second light, and the second curvature configures the portion of the second surface to impart the second light with a third power that reverses the first power and the second power.

18. The electronic device of claim 14, wherein the cover layer is thicker at the portion of the second surface than around the portion of the second surface.

19. An electronic device comprising:
a first waveguide configured to direct first light towards a first lens;
a second waveguide configured to direct second light towards a second lens;
a cover layer overlapping the first waveguide, the second waveguide, the first lens, and the second lens;
a third lens integrated into the cover layer and overlapping the first waveguide and the first lens, wherein the third lens is configured to transmit third light from an external object towards the first waveguide and is configured to reverse a first optical power imparted to the third light by the first lens; and
a fourth lens integrated into the cover layer and overlapping the second waveguide and the second lens, wherein the fourth lens is configured to transmit the third light towards the second waveguide and is configured to reverse a second optical power imparted to the third light by the second lens.

20. The electronic device of claim 19, wherein the cover layer has a first surface with a first three-dimensional curvature and a second surface opposite the first surface, wherein the third lens comprises a first portion of the second surface that has a second three-dimensional curvature that is different from the first three-dimensional curvature, and wherein the fourth lens comprises a second portion of the second surface that has a third three-dimensional curvature that is different from the first three-dimensional curvature.
